(19) United States
(12) Patent Application Publication
(10) Pub. No.: US 2008/0126475 A1
(43) Pub. Date: May 29, 2008

(54) Method And System For Providing Supplemental Information In A Presence Client-Based Service Message

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/564,470

(22) Filed: Nov. 29, 2006

(51) Int. Cl. G06F 15/16; G06F 15/173

(52) U.S. Cl. 709/203; 709/204

(57) ABSTRACT

A method for providing supplemental information in a presence client-based service message includes receiving a first message from one of a requesting client and a servicing client of a presence service. In one embodiment, the first message is compatible with a transmission format that provides a service element for carrying service information related to a service associated with the servicing client and made indirectly available to the requesting client via the presence service. When the first message is received, a supplemental element is identified in the first message. The supplemental element indicates that supplemental information other than the service information is allowed. A second message compatible with the transmission format is generated, where the second message includes the supplemental information as indicated by the supplemental element and the service element comprising the service information. The second message is sent to the other of the requesting client and the servicing client. In one embodiment, at least one of the first message is received and the second message is sent via a controlled communication channel that supports network access to at least one of the requesting client and the servicing client via a proxy associated with the presence service.

### CROSS-REFERENCE TO RELATED APPLICATIONS

The present application is related to co-pending U.S. patent application Ser. No. 11/160,157, entitled “METHOD, SYSTEM, AND DATA STRUCTURE FOR PROVIDING A GENERAL REQUEST/RESPONSE MESSAGING PROTOCOL USING A PRESENCE PROTOCOL,” filed on Jun. 10, 2005, and co-pending U.S. patent application Ser. No. 11/096,764, entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, both of which are commonly owned with the present application. The present application is also related to co-pending U.S. patent application Ser. No. 11/306,346, entitled “METHOD AND SYSTEM FOR PRESENTING PUBLISHED INFORMATION IN A BROWSER,” filed on Dec. 23, 2005, and commonly owned with the present application. Each of the above-cited related applications is incorporated here by reference in their entirety.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

More and more, users of electronic devices are exchanging digital information asynchronously in substantially real time over the Internet using asynchronous communication protocols. Unlike traditional communication protocols, such as HyperText Transport Protocol (HTTP), the commands of an asynchronous protocol, such as publish/subscribe (pub/sub) communication protocols, are structured such that there need not be a one-to-one correspondence between requests and responses exchanged between the devices. In some cases a sender of information via the protocol need not wait, nor expect a response from, a receiver. Moreover, a receiver need not send a request for each response. That is, a receiver may receive multiple responses to a request and/or may receive an unsolicited message. Thus, unlike HTTP where the reply is sent directly (synchronously) and only in response to the entity's request, the information can instead be sent in response to the sender's posting of the information (i.e., asynchronous to the request of information).

According to pub/sub communication protocols, an entity, referred to as a subscriber or subscriber client, is allowed to subscribe to information provided by another entity, referred to as a publisher, via a pub/sub service. Publishers publish to a distinct ID, typically a uniform resource identifier (URI) or uniform resource locator URL, and subscribers subscribe by providing the ID. The publisher posts, i.e., publishes, the information to the pub/sub service identifying the tuple to be created or updated, the service then transmits the published tuple information to all interested parties, i.e., subscribers, via notification messages. The published information can be read simultaneously by any number of subscribers. So long as the subscriber remains subscribed to the information, the subscriber will continue to receive notification messages corresponding to the publisher's postings.

Notably, as is used herein, the term “publish/subscribe” refers to the class of services and associated protocols where a subscriber receives only the most recently published information in a notification message resulting from a subscription. That is, the pub/sub service transmits to the subscriber only the most current state of the published information, and does not queue, or store, previously published data for retrieval when the subscriber is offline or otherwise unsubscribed, such as with email and traditional message queues. Thus, unlike typical message queuing services, when a subscriber logs on or subscribes to the pub/sub service, the subscriber receives only the current state of the information, as well as subsequent updates to the information while the subscriber is subscribed. The subscriber does not receive previous updates that may have occurred while the subscriber was offline or unsubscribed. In addition, the pub/sub services as described herein are not topic based subscription services where typically any number of publishers may contribute to a single subscription. In topic based subscription services, whether a published entity is sent to a subscriber is based on its topic or categorization. Such topic based subscription services are also sometimes referred to as pub/sub services.

A popular type of pub/sub service is a presence service, which allows a client to subscribe to presence information published by the client's friends, and allows the client to publish its presence information to the client's friends who are presently subscribed. Presence information includes status information relating to the client publisher. For example, presence information can include the client's status, e.g., “on-line,” “out-to-lunch,” and the client's preferred communication mode. A presence service can convey a user's presence on a network to other subscribing clients based on the user's connectivity to the network via a client device, such as a personal computer or mobile telephone.

The presence information describing a user's presence on the network can be used by applications and/or other services to provide what are referred to here as “presence applications”. A popular presence application is instant messaging (IM). IM applications include Yahoo's YAHOO MESSENGER®, Microsoft's MSN MESSENGER®, and America Online's AOL INSTANT MESSENGER or AIM®. IM applications use presence services to allow users to check the connectivity status of other users, i.e., who is connected to the network, and to determine whether the other users are available to participate in a communication session.

Typically, presence services and IM services are offered as added features of a user's subscription to a service provider or free of charge to users who register with the service provider. Accordingly, the number of users using presence and IM services has grown exponentially in a matter of a few years. With such a large number of users, there is an opportunity for a presence or IM service provider to generate revenue from advertising.

In co-pending U.S. patent application Ser. No. 11/096,764, entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, a system and method is described that allows a client supported by a presence service provider, such as an IM service provider, to share services and resources accessible to the client with other clients of the service provider. This sharing of new services requires requests and responses to be exchanged in accessing a service of the client with other clients. Many of the messages of these requests and responses require content to be presented to a user of either a requesting client or the servicing client, or provide an opportunity to present information to one of the users. Each time information is presented to a user in sharing a service, an opportunity is created allowing a service provider or a customer of a service provider, such as an advertiser, to include supplemental information, or content, for purposes such as advertising. Customer information can also be presented to one or both of the requester of the service and the sharer of the service during these opportunities.

### SUMMARY

Accordingly, a system and method for providing supplemental information in a presence client-based service message are described. According to an exemplary embodiment, a method includes receiving a first message from one of a requesting client and a servicing client of a presence service. In one embodiment, the first message is compatible with a transmission format that provides a service element for carrying service information related to a service associated with the servicing client and made indirectly available to the requesting client via the presence service. When the first message is received, a supplemental element is identified in the first message. The supplemental element indicates that supplemental information other than the service information is allowed. A second message compatible with the transmission format is generated, where the second message includes the supplemental information as indicated by the supplemental element and the service element comprising the service information. The second message is sent to the other of the requesting client and the servicing client. In one embodiment, at least one of the first message is received and the second message is sent via a controlled communication channel that supports network access to at least one of the requesting client and the servicing client via a proxy associated with the presence service.

According to another exemplary embodiment, a system is described for providing supplemental information in a presence client-based service message between a sending client and a receiving client, both of which are clients of a presence service. The system includes an intermediary server associated with the presence service and communicatively coupled to at least one of the sending client and the receiving client via a controlled communication channel that supports network access to at least one of the sending client and the receiving client. In one embodiment, the server includes a communication interface for receiving a first message from the sending client. The first message is compatible with a transmission format that provides a service element for carrying service information related to a service associated with the receiving client and made indirectly available to the sending client via the presence service. The server also includes an information insertion module configured to identify a supplemental element in the first message indicating supplemental information is allowed and to generate a second message compatible with the transmission format. The second message includes the service element comprising the service information, and supplemental information as indicated by the supplemental element. The information insertion module is configured to send the second message to the receiving client via the communication interface, wherein at least one of the first message is received and the second message is transmitted via the controlled communication channel.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a block diagram illustrating an exemplary system for providing supplemental information in a presence client-based service message according to an exemplary embodiment;

FIG. 2 is a block diagram illustrating the system in more detail according to one exemplary embodiment;

FIG. 2A is a block diagram illustrating an exemplary presence protocol agent according to one embodiment;

FIG. 3 is a block diagram illustrating an exemplary presence server according to one embodiment;

FIG. 4 is a flow diagram illustrating a method for providing supplemental information in a presence client-based service message according to an exemplary embodiment;

FIG. 5 is an exemplary user interface according to one embodiment; and

FIG. 6A and FIG. 6B are block diagrams illustrating the system according to two other embodiments.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to an exemplary embodiment, a method and system for providing supplemental information in a presence client-based service message is described. A pub/sub communication architecture and its underlying messaging protocol allow published information to be sent to a subscriber as it is received, in many instances, substantially in real-time in relation to the publication of the information. Information is published within the pub/sub communication architecture using a publish command. The published information can then be communicated to a subscriber using a notify command. The notify command can either include the published information or can provide a reference to the published information.

Well known pub/sub communication protocols include presence protocols, such as XMPP-IM, SIP SIMPLE, and RVP, which are used by presence services, and Jabber Software Foundation's pub/sub protocol as specified in Jabber Enhancement Proposal (JEP) JEP0060: Publish-Subscribe. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence”, each of which are published and owned by the Internet Society and incorporated here in their entirety by reference.

Generally speaking, one or more presence servers are used to provide presence services. The function of a presence server, however, can be incorporated, either in whole or in part, into other entities. For example, according to the presence service model described in RFC 2778, two distinct agents of a presence service client are defined. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from a presence service on behalf of a presence client.

The presence model of RFC 2778 describes two types of watchers, referred to as “subscribers” and “fetchers”. A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group that exists outside of the presence model, but can also represent software or other services capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

By way of example, aspects of an exemplary embodiment described here can employ a presence protocol as the pub/sub communication protocol. It should be understood, however, the relevant techniques described here can be performed using any pub/sub communications protocol as defined herein. Additionally, the exemplary embodiment described herein is not limited to the use of a pub/sub protocol for all communications described. Other known protocols, e.g., HTTP, can also be used.

According to pub/sub communication protocols, the pub/sub service stores and organizes information provided by the publisher and by the subscriber in data entities referred to as tuples. A tuple, in its broadest sense, is a data object containing one or more elements. As a pub/sub service, the presence service manages presence tuples, each of which contain a status element that stores presence information relating to the principal associated with the presence tuple. Presence tuples can also include other elements that can store other published information associated with the principal. The published information may include general contact information of the publisher, such as name, telephone number, email address, postal address, an IP addresses or URLs associated with the publisher, and the like, as well as other data or content. As used here, the tuple can also be a representation that maps field names to certain values to indicate that an entity or object (e.g., the principal) includes certain components, information, and/or perhaps has certain properties.

As stated above, a presence service can provide presence information relating to a community of presence clients so that the presence clients can determine each other's availability. A presence service can also be used to facilitate access to services associated with a presence client, referred to here as a servicing client, by other presence clients, as disclosed in co-pending U.S. patent application Ser. No. 11/096,764, entitled “SYSTEM AND METHOD FOR UTILIZING A PRESENCE SERVICE TO FACILITATE ACCESS TO A SERVICE OR APPLICATION OVER A NETWORK,” filed on Mar. 31, 2005, and commonly owned with the present application and herein incorporated by reference. Here, a service, e.g., a web service, managed by a servicing client can be made available to a community of remote presence clients, referred to as requesting clients, of a presence service. The service is made available by registering the service on the presence service, which stores presence information related to the service in a tuple. The presence information related to the available service is then provided to the requesting clients so that they can determine which services are available, and with whom or what the services are associated.

In one aspect, a requesting client can select the service and send a message requesting access the service to the servicing client. The request can be sent directly to the servicing client, via a service proxy associated with either the requesting or servicing clients, and/or via the presence service. When the request is received, the servicing client can process the request and send a response back to the requesting client directly, via the service proxy and/or the presence service. In this manner, the presence service can facilitate access to a selected service securely from the standpoint of the requesting client and of the servicing client.

According to an exemplary embodiment, the request message from the requesting client and/or the response message from the servicing client can include a supplemental element that indicates that supplemental information, e.g., an advertisement, is allowed. The supplemental element can indicate, among other things, where the supplemental information can be inserted, how it can be displayed, and what the content should be. The supplemental element is interpreted and the supplemental information is inserted into the request or response message. When the request or response message is received by the servicing and requesting clients, respectively, the supplemental information is presented to the receiving client as indicated by the supplemental element. In this manner, advertisements can be included in presence client-based service messages thereby generating revenue for the presence service, the servicing client, and/or the requesting client.

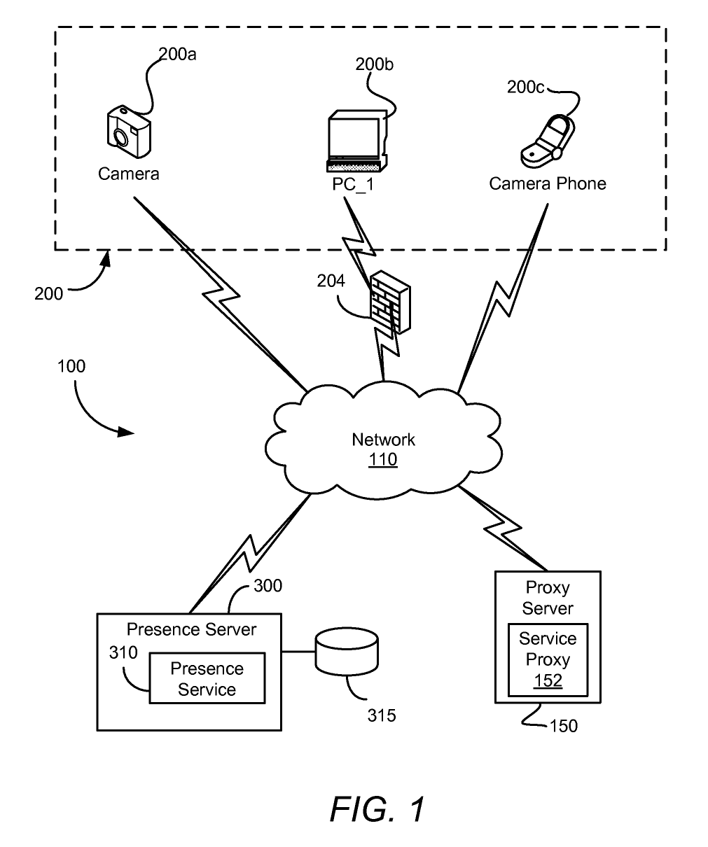

FIG. 1 is a block diagram illustrating an exemplary system according to one embodiment. The system 100 includes a plurality of client devices 200 in communication with a server 300 that hosts a presence service 310 and a proxy server 150 that hosts a service proxy 152. Example types of such devices include a camera phone 200c, a personal digital assistant (PDA), a personal computer (PC) 200b, a network-enabled camera 200a, and the like. Each device 200 includes at least one presence client, such as a subscriber client, that is configured to communicate with the presence service 310 using a presence communication protocol. In one embodiment, the subscriber client can be a subscription browser, as disclosed in co-pending U.S. patent application Ser. No. 11/160,612 entitled “METHOD AND APPRATUS FOR BROWSING NETWORK RESOURCES USING AN ASYNCHRONOUS COMMUNICATIONS PROTOCOL,” filed on Jun. 30, 2005, and commonly owned with the present application and herein incorporated by reference.

In one embodiment, the client devices 200 are configured to communicate with each other and with the proxy 150 and presence 300 servers via a network 110, such as the Internet. As is shown, the proxy server 150 hosts the service proxy 152, which serves as a proxy among the devices 200 in the network 110. The service proxy 152 permits the devices 200 and the presence service 310 to communicate with one another through a firewall 204 in a known manner. In one embodiment, the service proxy 152 can be associated with the presence service 310, and/or associated with at least one of the client devices 200. While shown residing in a separate server 150, the service proxy 152 can also reside in the presence server 300. In addition, while only one service proxy 152 is shown in FIG. 1, a plurality of service proxies 152 can be implemented to handle network access to and from client devices 200 that are protected by one or more firewalls 204.

As is shown, the presence server 300 hosts the presence service 310. The presence service 310 is configured to process subscriptions by presence clients to information published by other presence clients. In an exemplary embodiment, published information and subscription information can be stored in a data store 315. Although the data store 315 is depicted as having a particular location remote from the devices 200, nothing prevents the data store 315 from being stored in another location. For example, all or a portion of the presence information may be stored in a memory structure (not shown) on the devices 200 or on another memory structure (not shown).

As stated above, the presence service 310 can facilitate secure access to services and applications managed by a client device 200 by authorized users or devices. According to one embodiment, at least one client device, e.g., the personal computer 200b, is a servicing client that shares a plurality of services and applications with the community of requesting clients 200a, 200c via the presence service 310. For example, such services can include printing, file system access, local database access, and web server services, and such applications can include web-based applications.

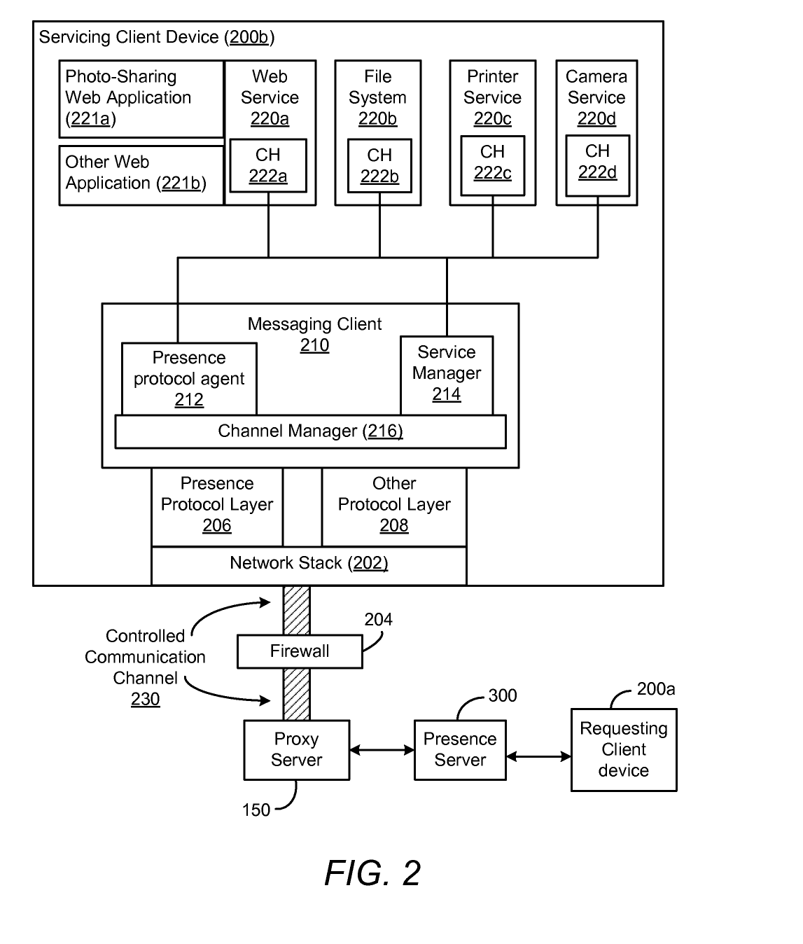

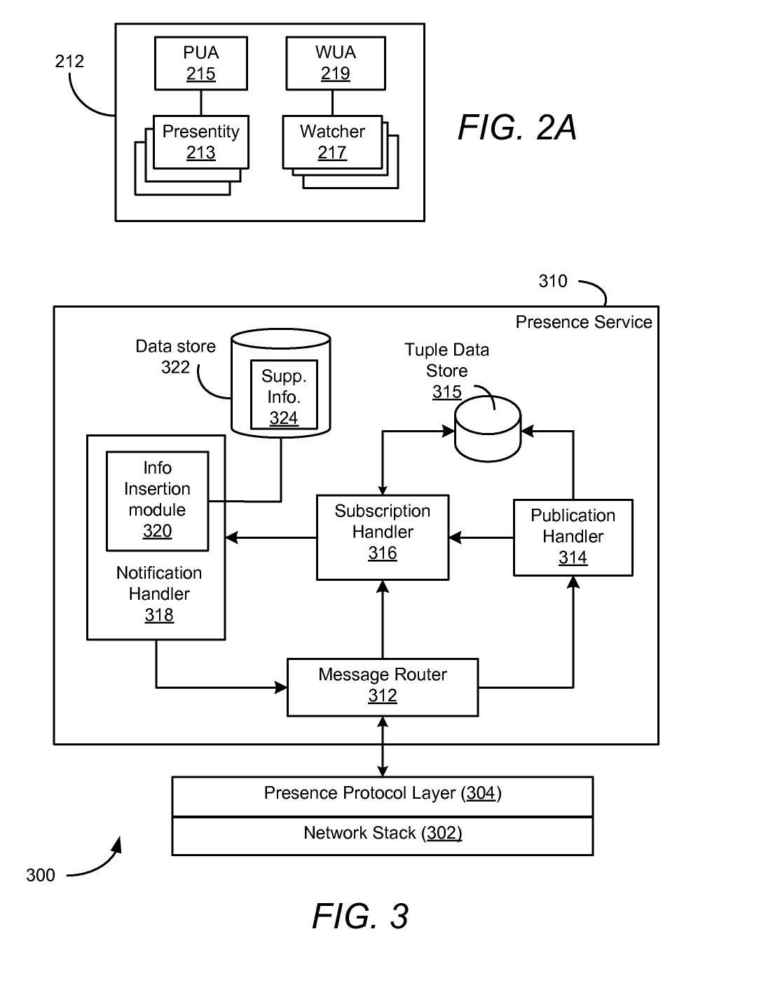

FIG. 2 is a block diagram of an exemplary servicing client device, e.g., 200b, according to one embodiment. In this example, the servicing client device 200b is a personal computer that manages a plurality of services 220a-220d and applications 221a, 221b. For example, the device 200b can manage a web server service 220a, a file system access service 220b, a printer service 220c, a camera service 220d, a photosharing web application 221a and other web applications 221b. The services 220a-220d and applications 221a, 221b are protected by a firewall 204. In one embodiment, each service 220a-200d and application 221a, 221b is a presence client of the presence service 310.

The servicing client device 200b includes a messaging client 210 through which each of the presence clients, e.g., the services 220a-200d and applications 221a, 221b, in the device 200b can be represented to the presence service 310 and made known to other clients. In one embodiment requests to and responses from the services 220a-220d and applications 221a, 221b can be processed through the presence service 310. For example as depicted in FIG. 2, the messaging client 210 includes a presence protocol agent component 212, a service manager component 214, and a communication channel manager 216. The presence protocol agent component 212 is configured to send and receive presence information relating to any of the presence clients, e.g., services 220a-220d and applications 221a, 221b, using a presence communication protocol.

FIG. 2A is a block diagram of an exemplary presence protocol agent component 212 according to one embodiment, which includes at least one presentity 213 and a presence user agent (PUA) 215. Each presentity 213 can be associated with a presence client 220a-220d, 221a, 221b and is used to publish presence information including the status of the associated presence client, e.g., the web server service 220a, to the presence service 310 via the network 110 (FIG. 1). The PUA 215 serves as an interface between the presence clients 220a-220d, 221a, 221b and their respective presentities 213. Corresponding to this embodiment of the servicing client device 200b, an embodiment of the presence service 310 maintains a “services list” associated with a tuple of a user of the servicing client device 200b. The services list identifies the tuples of each of the presence clients 220a-220d, 221a, 221b allowing a watcher of the user's tuple to access the tuples associated with the services 220a-220d and applications 221a, 221b.

The presence protocol agent component 212 also includes at least one watcher 217 and a watcher user agent (WUA) 219. In one embodiment, each watcher 217 is associated with a presence client, e.g., 220a, and is configured to receive presence information to which the presence client is subscribed from the presence service 310. The presence information received by the watcher 217 is interpreted by the WUA 219, which provides an interface between the presence client 220a and the watcher 217. As with presentities 213 and PUAs 215, watchers 217 and WUAs 219 may be integrated with each client 220a-220d, 221a, 221b or may be an external service used by or acting on behalf of the clients 220a-220d, 221a, 221 b.

Referring again to FIG. 2, the service manager 214 is configured to route messages, e.g., incoming requests and outgoing responses, to and from services 200a-200d in conjunction with command handlers 222a-222d associated with each service 220a-220d. In general, these messages can be transmitted using protocols other than the presence protocol, such as HTTP.

In one embodiment, the messaging client 210 can send and receive presence information to and from the presence server 300 via a presence protocol layer 206 and a network stack component 202. The network stack component 202 is used to exchange information received or transmitted at the physical layer (e.g., the wire, air interface, or fiber optic cable) of the network 110, through the data link (e.g., ETHERNET, 802.11 WIFI), transport/network (e.g., TCP/IP) and application (e.g., XMPP) layers of the stack. The presence protocol layer 206 processes messages received from the presence server 300 over the network 110. In a similar manner, messages using other communication protocols can be sent to and received from other servers, e.g., the proxy server 150, via an other protocol layer 208 and the network stack component 202.

According to an exemplary embodiment, the messaging client 210 uses a communication channel manager 216 to create and manage a controlled communication channel 230 between the client device 200b and an intermediary server that is associated with the presence service 310. The controlled communication channel 230 supports network access to the client device 200b through the intermediary server. In one embodiment, the intermediary server can be the proxy server 150 that provides network access by the presence service 310 to the client device 200b when the client device 200b is behind a firewall 204. In another embodiment, the intermediary server can be the presence server 300 that hosts the presence service 310.

According to one embodiment, the controlled communication channel 230 is a shared channel that can include one or more connections using one or more listening ports and/or one or more datagram ports. The communication channel manager 216 manages the sharing of the controlled communication channel 230 by the various clients 220a-220d, 221a, 221b and the protocols they use.

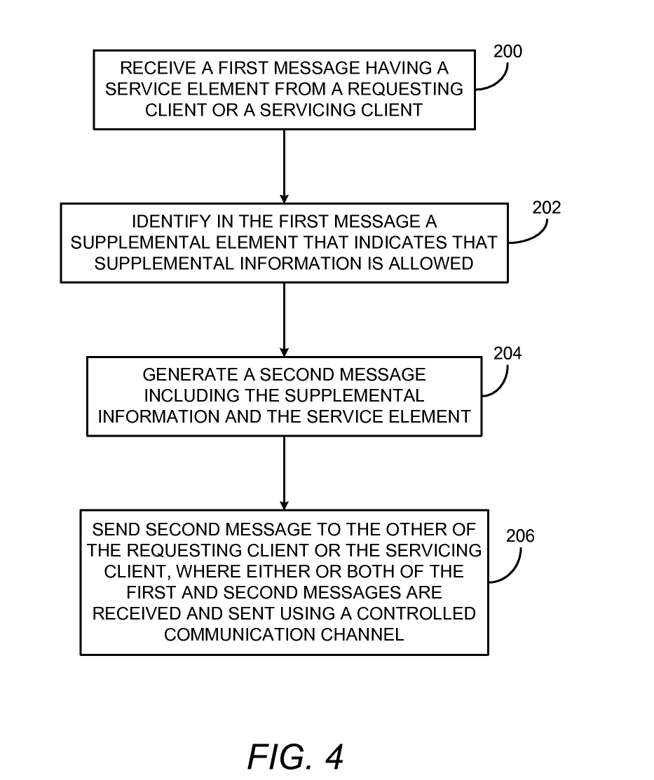

FIG. 3 is an exemplary block diagram of the presence server 300 according to one exemplary embodiment. The presence server 300 includes a presence protocol layer 304 coupled to a network stack component 302. The presence protocol layer 304 processes presence protocol data packets including presence commands received from the network 110 and passes the commands to the presence service 310. The presence service 310 includes a message router 312 configured to receive and process presence commands from the presence protocol layer 304. In one embodiment, the message router 312 directs subscribe commands to a subscription handler 316 that is configured to handle subscribe commands, directs publish commands to a publication handler 314 that is configured to handle publish commands, and sends notify commands on behalf of a notification handler 318.

The subscription handler 316 processes subscribe commands and other tasks associated with subscriptions. In one embodiment, the subscription handler 316 processes a subscribe command by placing a subscribing client 200 on a subscription list associated with the tuple. In addition, the subscription handler 316 authenticates and authorizes the client 200, manages rosters and subscription lists, and uses the notification handler 318 to construct notification response messages informing clients 200 when new information is available. The publication handler 314 processes publish commands and coordinates with the subscription handler 316 the publication of tuple data to ensure that subscribing clients 200, if any, are notified via the notification handler 318.

As stated above, the presence service 310 can be used to facilitate the sharing of services 220a-220d managed by a servicing client 200b among a community of requesting clients 200a, 200c. According to an exemplary embodiment, the presence service 310 can include a means for receiving a first message from either a requesting client, e.g., 200a, or a servicing client, e.g., 200b, a means for identifying a supplemental element in the first message that indicates supplemental information is allowed, a means for generating a second message including the supplemental information as indicated by the supplemental element, and a means for sending the second message to the other of the requesting client 200a or the servicing client 200b. For example, in one embodiment, the publication handler 314 can be configured to receive the first message, and the notification handler 318 can be configured to send the second message to the other of the requesting 200a or servicing 220b client.

According to one embodiment, the presence service 310 can also include an information insertion module 320 that is configured to identify the supplemental element in the first message that indicates that supplemental information is allowed, and to generate the second message including the supplemental information using the notification handler 318. In one embodiment, the information insertion module 320 can be integrated in the notification handler 318, as shown. Alternatively, the information insertion module 320 can be a stand alone module that works independent of the notification handler 318. In one embodiment, the information insertion module 320 is coupled to a supplemental information store 322 that stores supplemental information 324 to be inserted into the second message.

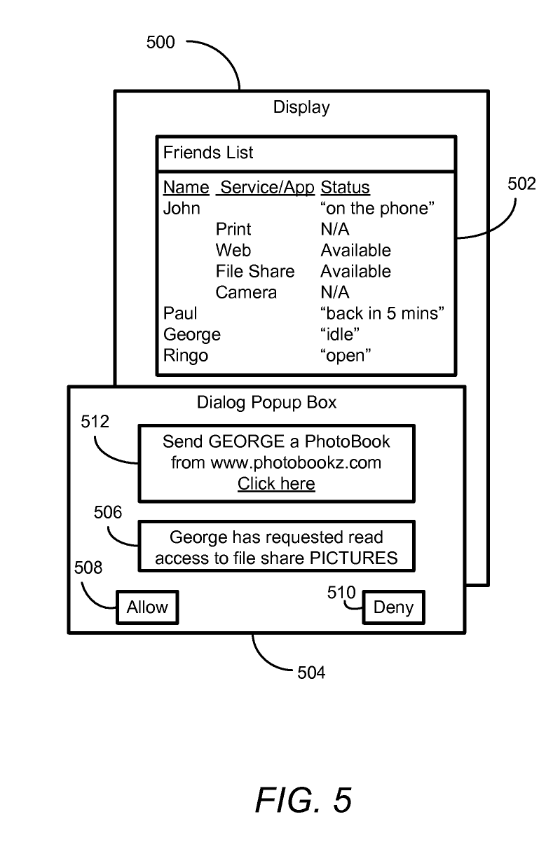

FIG. 4 is a flow diagram illustrating a method for providing supplemental information 324 in a presence client-based service message according to an exemplary embodiment where the presence service 310 processes requests for services and responses to such requests. Referring to FIGS. 1-4, the method begins by receiving a first message from either a requesting client 200a or a servicing client 200b of the presence service 310 (block 400). In one embodiment, the first message can be received directly from the sending client 200a or 200b or via a service proxy 152 when the sending client 200b is behind a firewall 204. In either case, in this embodiment, the first message is received using the controlled communication channel 230 associated with the sending client 200a or 200b. Below, other embodiments are described in which a second message is sent using the controlled communication channel 230 associated with the receiving client 200a or 200b. In any event, at least one of the first and second messages are exchanged between the sending/receiving clients 200a or 200b using the controlled communication channel 230.

In an exemplary embodiment, the first message is compatible with a transmission format that provides a service element for carrying service information related to a service, e.g., 220a, associated with the servicing client 200b and made indirectly available to the requesting client 200a via the presence service 310. As used here, indirect access to a service is access through an intermediary where the intermediary performs at least one of protocol translation, address translation, and message format translation on behalf of the requesting client 200a enabling communication between the requesting client 200a and the servicing client 200b. In this embodiment, the service 220a is made indirectly available to the requesting client 200a when the presence service 310 serves as an intermediary for the servicing client 200b thereby allowing access to the service 220a through the controlled communication channels 230 associated with the requesting 200a and servicing 200b clients.

In one embodiment, the service information can include a request for access to the service 220a, a response to a request, or both. In addition, the transmission format of the first message can provide a supplemental element that indicates whether supplemental information 324 is allowed. In one embodiment, the requesting 200a or servicing 200b client may use templates that include tags indicating where supplemental information 324 may be inserted. The templates may be provided by the presence service 310, the requesting 200a or servicing 200b clients, or a third party.

In one embodiment, the first message can be sent using a presence protocol, an instant message (IM) protocol, or other protocol. For example, the first message can be sent using a presence protocol described in co-pending U.S. patent application Ser. No. 11/160,157, entitled “METHOD, SYSTEM, AND DATA STRUCTURE FOR PROVIDING A GENERAL REQUEST/RESPONSE MESSAGING PROTOCOL USING A PRESENCE PROTOCOL,” filed on Jun. 10, 2005, and commonly owned with the present application and incorporated here by reference in its entirety.

In one embodiment, when the first message is received by the presence server 300, the first message is routed to the presence protocol layer 304 of the server 300 via the network stack component 302, which passes the first message to the message router 312. Typically, the first message includes a publish command and the first message is passed to the publication handler 314 for processing. In one embodiment, a presence protocol is used and the service information is included in at least a portion of a tuple. The publication handler 314 can store at least a portion of the tuple in the tuple data store 315, and passes control to the subscription handler 316, which determines active subscriptions associated with the tuple. If an active subscription is detected and/or the first message is a directed publish, the notification handler 318 is invoked to generate a notification message.

When the first message is received, the supplemental element in the first message is identified (block 402). In one embodiment, the information insertion module 320 can be configured to identify the supplemental element. In another embodiment, when the notification handler 318 is invoked to generate the notification message based on the updated tuple information, the notification handler 318 can identify the supplemental element in the first message. In one embodiment, the supplemental information 324 is information other than the service information and can include advertisements and other information not related to the request for services or the response to such requests.

According to an exemplary embodiment, the notification handler 318 can identify the supplemental element through the use of a schema or format specification by the notification handler 318. The supplemental element may be identified, for example, by name or by position, either of which may be absolute or identified contextually. In one embodiment, the supplemental element can be embedded in the request or response in the message, but in some embodiments may be separated from the request or response but associated with information indicating the location where the supplemental information 324 can be placed.

The following are examples of exemplary first messages that provide a service element for carrying service information and a supplemental element that indicates supplemental information 324 is allowed.

### EXAMPLE 1

<channel>
<session id=”0x02ac52”/>
<app-proto-type>HTTP</app-proto-type>
<app-proto-data>
GET ./home
Host: localhost
User-Agent: Mozilla/5.0 (X11; U; Linux i686; en-US; rv:1.4.1) Gecko/
20031114
Accept: text/html;q=0.9,text/ \plain;q=0.8,video/x-
mng,image/png,image/jpeg,image/gif;q=0.2,*/*;q=0.1
Accept-Language: en-us,en;q=0.5
Accept-Encoding: gzip,deflate
Accept-Charset: ISO-8859-1,utf-8;q=0.7,*;q=0.7
Additional-Info: dialog | email | SMS
</app-proto-data>
</channel>

In Example 1 above, the first message is a service request from a requesting client 200a. The message illustrates an XML protocol using a <channel> document to multiplex multiple protocols over a single shared connection (an embodiment of the controlled communication channel 230). The channel document includes an element identifying a session ID for multiplexing, an embedded protocol type, e.g., HTTP, and an element, <app-proto-data>, for holding the embedded protocol data. The URL, ./home, is relative because the web server is known to the channel's owner and its address might not be known to anyone else.

The message is an HTTP Get command and includes a new HTTP header, “Additional-info”. This header, when sent to the presence service 310, can be blank or can contain attributes informing the presence service 310 of characteristics of supplemental information 324 that can be added, and appropriate ways for displaying the supplemental information 324 on the servicing client 200b. For example, the “dialog |email| SMS” tells the presence service 310 that the supplemental information 324 can be added to the header where it can be displayed on the servicing client 200b in a dialog. No further restrictions are given in the message. In one embodiment, the presence service 310 can provide the supplemental information 324 via a separate email or SMS message. In another embodiment, these options may be added at the presence service 310 and carried out on the servicing client 200b.

In Example 2 below, the first message is an HTTP response to the service request in Example 1.

### EXAMPLE 2

```
<channel>
<session id=”0x02ac52”/>
<app-proto-type>HTTP</app-proto-type>
<app-proto-data>
HTTP/1.1 200 OK
Date: Wed, 08 Sep 2004 17:33:31 GMT
Server: Apache/1.3.27 (Unix) (Red-Hat/Linux) PHP/4.1.2
Last-Modified: Wed, 08 Sep 2004 17:02:40 GMT
Content-Length: xxx
Content-Type: text/html
<!DOCTYPE HTML PUBLIC “-//W3C//DTD HTML 4.01//EN”
  “http://www.w3.org/TR/html4/strict.dtd”>
<HTML>
  <HEAD>
    <TITLE>My first HTML document</TITLE>
  </HEAD>
  <BODY>
      <ISP:INFO xmlns:ISP=http://isp.net/proprietary/ads/ type=
      ”banner”
      content-type=”image/*”/>
      <P>Hello world!
  </BODY>
</HTML>
</app-proto-data>
</channel>
```

Here, the servicing client 200b responds via the shared communication channel 230 using the same XML channel document tags. In the response message, a new HTML tag, <info>, is defined in a name space private to the ISP. When the presence service 310 receives the response, it detects the <info> tag and replaces it using the supplemental information 324 in the tag. In one embodiment, the tag directs the information to be added as a banner which takes the form of an image. The presence service 310 can use information in the content, the HTTP header, the <channel> document, and information gathered about the sender or receiver, for example, to select supplemental information 324 to add to the response.

In Example 3, below, the first message is a PIDF service request with exemplary extensions to PIDF enabling a request.

### EXAMPLE 3

```
<?xml version=“1.0” encoding=“UTF-8”?>
<presence xmlns=“urn:ietf:params:xml:ns:pidf”
entity=“sip:tsmothers@example.com”>
  <tuple id=“sg89ae”>
  <S:service-request
    xmls:S=”http://schemas.example.org/service/”>
    <isp:info xmlns:isp=”http://isp.net/proprietary/ads/”/>
    <S:fileshare>
      <S:cmd>
        <S:id>list</S:id>
        <S:param>
          <S:name>path</S:name>
          <S:value>./PHOTOS</S:value>
        </S:param>
      </S:cmd>
    </S:fileshare>
  </S:service-request>
  </tuple>
</presence>
```

The request is directed to a file sharing service on the servicing client 200b to execute the command, “list”, with a parameter “path” specified as ./PHOTOS. In this embodiment, the relative path can be used or alternately, standard path names recognized by service clients 200b can be used. The message includes an <info> element with no attributes. This leaves the presence service 310 and/or the service client 200b free to determine what and how to present supplemental information 324.

Once the supplemental element is identified, a second message compatible with the transmission format is generated that includes the supplemental information 324 and the service element having the service information (block 404). In one embodiment, the second message is the notification message generated by the notification handler 318. When the supplemental element is identified, the notification handler 318 can pass the notification message to the information insertion component 320, which can be configured to select and retrieve the supplemental information 324 from the supplemental information data store 322 and to insert the selected supplemental information 324 into the second message as indicated by the supplemental element.

In one embodiment, the supplemental information 324 can be selected based on attributes associated with the service, the service information, and/or the supplemental element. For example, attributes associated with the service can include a service type, service content, service and service protocol. Attributes associated with the service information can include the identity of the requesting client 200a or servicing client 200b and attributes of the same, and keywords in the service information. Attributes associated with the supplemental element can include a MIME type associated with the supplemental element, size, font, color, location, and preferred presentation mode.

Thus, the supplemental information 324 can be selected based on the service type, the service content, and/or the service protocol associated with the service. In addition, the supplemental information 324 can be selected based on a MIME type, a size, a font, a color a location and/or a preferred display mode associated with the supplemental element. When more than one second message is generated, e.g., because more than one subscriber is subscribed to the tuple, the supplemental information 324 selected can be different for each second message based on the receiving client 200a or 200b. Accordingly, the supplemental information 324 selected can be tailored to the service requested or provided and to the receiving client 200a or 200b.

In one embodiment, the information insertion module 320 is configured to use at least a portion of the first message, such as the supplemental element, as content in the second message. In one embodiment, the content of the supplemental element can be a placeholder, which the supplemental information 324 simply replaces. In another embodiment, the supplemental information 324 can be placed in the supplemental element along with the content of the supplemental element.

The following are examples of second messages that include the service element for carrying service information and the supplemental information 324.

### EXAMPLE 4

```
NOTIFY sip:user@watcherhost.example.com SIP/2.0
  Via: SIP/2.0/TCP server.example.com;branch=z9hG4bKna998sk
  From: <sip:resource@example.com>;tag=ffd2
  To: <sip:user@example.com>;tag=xfg9
  Call-ID: 2010@watcherhost.example.com
  Event: presence
  Max-Forwards: 70
  CSeq: 8775 NOTIFY
  Contact: sip:server.example.com
  Content-Type: application/cpim-pidf+xml
  Content-Length: ...
  Additonal-Info: dialog;source=http://ad.server.com/013707/056.txt
  [PIDF Document]
```

In Example 4, the second message is a SIP notification. Because SIP is an extension of HTTP, one embodiment can use the Additional-info HTTP header described above. In one embodiment, the Additional-info header can be modified to specify that the supplemental information 324 be displayed in a dialog box and that the source of the supplemental information 324 be provided by the URL.

In addition, or alternatively, an element can be added to the PIDF content of the SIP NOTIFY command as described in the earlier PIDF example. Because this is a second message, the content can be inserted or linked to and options for presentation can be modified by the presence service 310 from those in the first message if any.

Example 5, below, is an example of a second message using an instant message protocol, RVP.

```
NOTIFY /instmsg/aliases/maxb HTTP/1.1
Host: im.fabrikamwidgets.com
RVP-Notifications-Version: 0.2
RVP-Ack-Type: DeepOr
RVP-Hop-Count: 1
RVP-From-Principal: http://im.example.com/instmsg/aliases/deriks
Content-Type: text/xml
Content-length: XXXX
RVP-PartitionCount=1.5.2
RVP-PartitionTotal=1.15.6
<?xml version=“1.0”?>
  <Z:notification xmlns:D=“DAV:”
    xmlns:Z=“http://schemas.microsoft.com/rvp/”>
    <Z:message>
      <S:service-response
        xmls:S=”http://schemas.org/service/”>
        <isp:info
          xmlns:isp=”http://isp.net/ads/”/>
        <S:dirlist>
          <S:name>pets</S:name>
          <S:name>people</S:name>
          <S:name>events</S:name>
        </S:dirlist>
        <S:filelist/>
      </S:service-response>
    </Z:message>
  </Z:notification>
```

Because RVP is an extension of HTTP, a header, such as the exemplary Additional-info header, can be used as previously described. In the example above, the message element includes a response in XML format which may be an extension of the message schema or may use a separate namespace as in the example.

Once the second message has been generated, the second message is sent from the presence service 310 to the other of the requesting client 200a or the servicing client 200b (block 406). According to an exemplary embodiment, the second message is sent via the controlled communication channel 320 of the receiving client 200a or 200b. In one embodiment, the information insertion module 320 can be configured to send the second message using the notification handler 318. For example, once the supplemental information 324 is selected and inserted into the notification message, the information insertion module 320 can return the notification message to the notification handler 318. The notification handler 318 can transmit the notification message to the receiving client 200a or 200b using the presence protocol supported by the presence protocol layer 304 via the network stack component 302. In one embodiment, the second message can be sent to or intercepted by the service proxy 152 and forwarded to the receiving client 200b via the controlled communication channel 320 thereby allowing the second message to traverse the firewall 204.

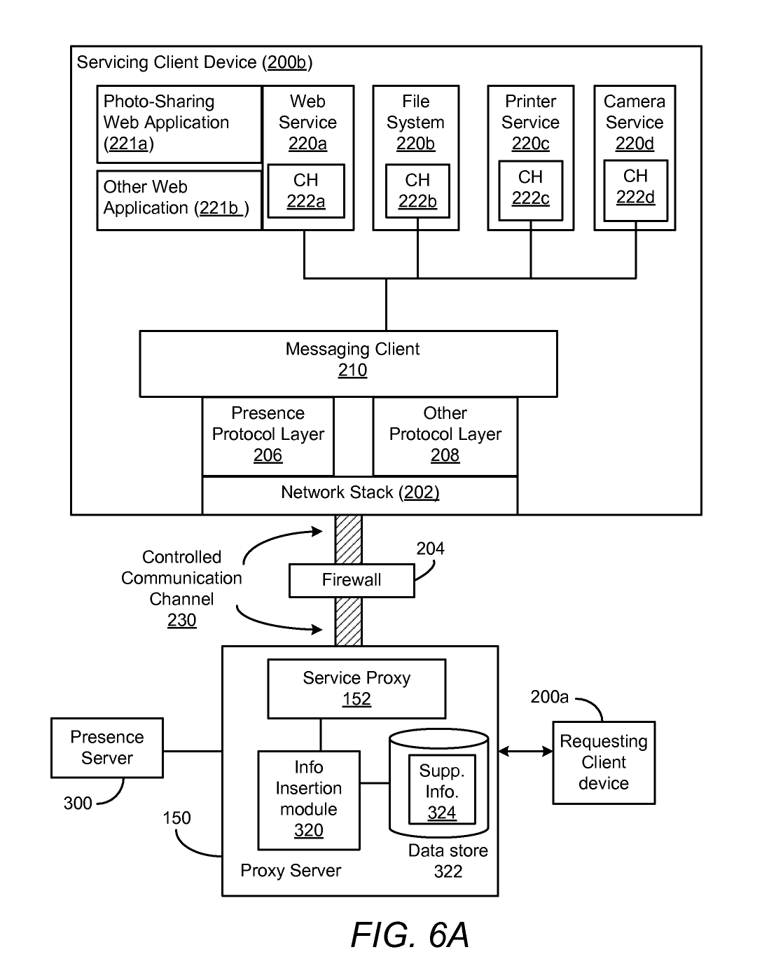

FIG. 5 is an illustration of an exemplary user interface on the servicing client 200b according to one embodiment. The display 500 includes a friends list 502 associated with the user of the client device 200b. In one embodiment, the friends list 502 provides the name of each contact on the friends list, available services associated with each contact, and the status of the friend and the associated available services. Other presence information can be included in the friends list 502, such as contact information. In this manner, the user can determine which services 220a-220d and applications 221a, 221b are available on a particular friend's device 200b, and select a service, e.g., 220a.

According to an exemplary embodiment, the display 500 can also include a popup dialog box 504, which informs the user of the servicing client 200b that a friend, George, has sent a request to access a file share named PICTURES according to a message box 506. The popup dialog box 504 allows the user to authorize the request by selecting an allow button 508 or to reject the request by selecting a deny button 510. In one embodiment, the supplemental information 324 has been inserted and can be displayed in a supplemental information area 512. Here, the supplemental information 324 is an advertisement for photo books. This supplemental information 324 was selected and inserted based on factors such as the type of service requested, the keyword “PICTURES” in the request, and the fact that the message is a request. The supplemental information 324 includes a link designated by “Click here” which starts a process guiding the user through the process of building a photobook for George.

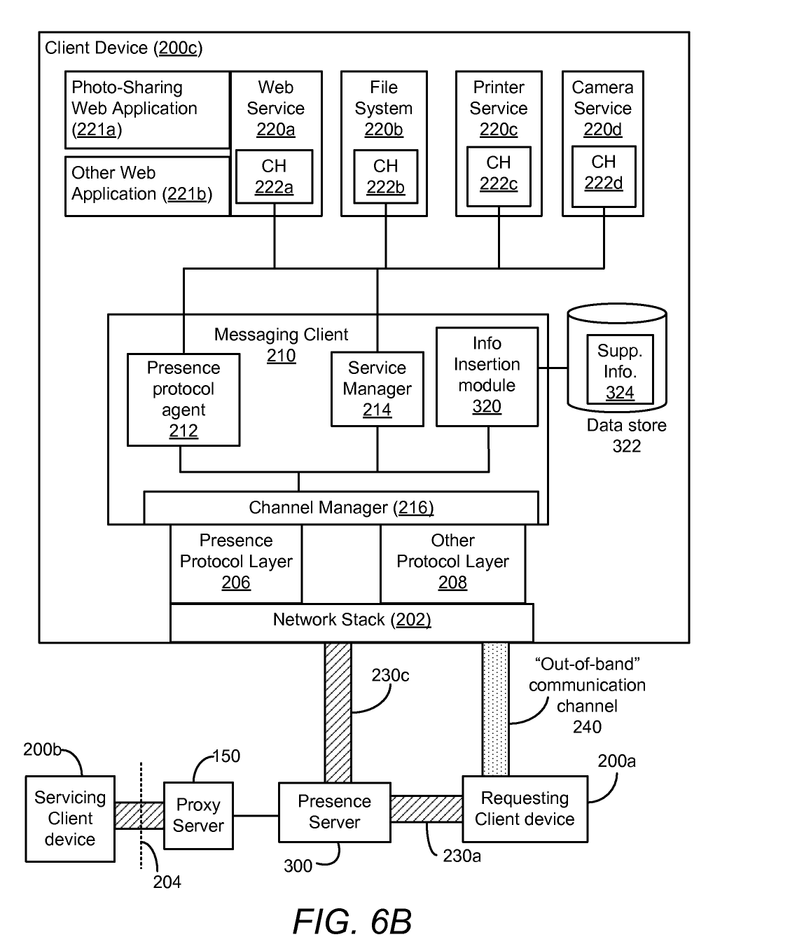

In the exemplary embodiment described above, the first and second messages are processed by an intermediary server, e.g., the presence server 300, that includes the presence service 310. According to another embodiment, the first and second messages can be processed by an intermediary server 150 that includes the service proxy 152. In this embodiment, shown in FIG. 6A, the requesting client 200a and the servicing client 200b send and receive request and response messages via the service proxy 152 that controls network access to the servicing client 200b through the firewall 204 via the controlled communication channel 230. In one embodiment, the service proxy 152 is configured to establish the controlled communication channel 230 by using the presence service credentials associated with the servicing client 200b and to use the communication channel 230 to send and receive messages to and from the servicing client 200b.

In one embodiment, the proxy server 150 includes the information insertion module 320 and the supplemental information data store 322 so that the supplemental element can be identified, and the supplemental information 324 can be selected and inserted into the second message before it is sent to the receiving client 200a or 200b. In this embodiment, the request and response messages can be sent and received using a communication protocol other than the presence protocol, e.g., HTTP, so long as the communication protocol used is supported by the service proxy 152.

In the exemplary embodiments described above, the first message is received and the second message is sent using at least one controlled communication channel 230 associated with the requesting 200a and/or servicing 200b clients. In another embodiment, only one of the first and second messages is received and sent using the controlled communication channel 230. In this embodiment, shown in FIG. 6B, the servicing client 200c is not behind a firewall and a service proxy 152 is not required. The channel managers 216 in both clients 200a, 200c create and manage respective controlled communication channels 230a, 230c between the requesting 200a and the servicing 200c clients, respectively, and the presence server 300.

As described above, the requesting client 200a can send or receive messages to and from the servicing client 200c through the presence server 300 using a presence protocol via the controlled communication channels 230a, 230c. In another embodiment, because the servicing client 200c is not behind a firewall, the requesting client 200a can send a service request message directly to the servicing client 200c via an out-of-band communication channel 240 that is separate from the controlled communication channel 230. Thus, the servicing client 200c can receive a first message from the requesting client 200a outside of the controlled communication channel 230c associated with the presence server 300.

In one embodiment, the servicing client 200c can include the information insertion module 320 and the supplemental information data store 322 so that the supplemental element can be identified, and the supplemental information 324 can be selected and inserted into the second message, e.g., the response to the request. In one embodiment, the second message that is generated by the servicing client 200c and that includes the supplemental information 324 is sent to the requesting client 200a through the presence server 300 via the controlled communication channels 230a, 230c. In another embodiment, the servicing client 200c can receive the first message, e.g., the service request, via the controlled communication channel 230c and send the second message, e.g., the response, directly to the requesting client 200a via the out-of-band communication channel 240.

The examples described above are not exhaustive. For example, referring to FIG. 6B, the client device 200c can be a requesting client that sends a service request to the servicing client 200b via the presence server 300. In one embodiment, the requesting client 200c can use the information insertion module 320 to insert the supplemental information 324 into the first message, e.g., the service request, as well as into the second message, as described above. In this embodiment, the presence server 300 is that shown in FIG. 3, which hosts the presence service 310 that also includes an information insertion module 320 and supplemental information data store 322. When the first message is received by the presence service 310, the insertion module 320 in the presence service 310 not only identifies the supplemental element, but also detects the supplemental information 324 in the supplemental element and inserts the supplemental information 324 in the first message into the second message. Thus, in this embodiment, the sending client 200a can control the content of the supplemental information 324 as well as the attributes associated with the supplemental information 324.

The executable instructions of a computer program for carrying out the methods illustrated in FIG. 4 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for providing supplemental information in a presence client-based service message, the method comprising:
receiving a first message from one of a requesting client and a servicing client of a presence service, the first message compatible with a transmission format that provides a service element for carrying service information related to a service associated with the servicing client and made indirectly available to the requesting client via the presence service;
identifying a supplemental element in the first message that indicates supplemental information is allowed, wherein the supplemental information is information other than the service information;
generating a second message compatible with the transmission format, the second message including the supplemental information as indicated by the supplemental element and the service element comprising the service information; and
sending the second message to the other of the requesting client and the servicing client, wherein at least one of the first message is received and the second message is sent via a controlled communication channel that supports network access to at least one of the requesting client and the servicing client via a proxy associated with the presence service.

2. The method of claim 1 wherein the service information includes at least one of a request from the requesting client and a response from the servicing client.

3. The method of claim 1 wherein generating the second message further comprises:
selecting supplemental information based on attributes associated with at least one of the service, the service information, and the supplemental element; and
inserting the selected supplemental information into the second message as indicated by the supplemental element.

4. The method of claim 3 wherein selecting the supplemental information includes:
determining at least one of a service type, a service content, and a service protocol associated with the service, and at least one of a MIME type, a size, a font, a color, a location, and a preferred display associated with the supplemental element; and
choosing the supplemental information based on at least one of the service type, the service content, and the service protocol associated with the service and based on at least one of the MIME type, the size, the font, the color, the location, and the preferred display associated with the supplemental element.

5. The method of claim 3 wherein inserting the selected supplemental information into the second message comprises using at least a portion of the first message including the supplemental element as content in the second message and one of replacing in the content the supplemental element with the supplemental information, and placing in the content the supplemental information into the supplemental element.

6. The method of claim 1 wherein generating the second message further comprises:
detecting whether the supplemental element of the first message includes the supplemental information; and
inserting the supplemental information in the first message into the second message when the supplemental information is so detected.

7. The method of claim 1 wherein at least one of receiving the first message and sending the second message comprises using the controlled communication channel associated with the presence service.

8. The method of claim 1 wherein the proxy is a presence service configured to send a notification message including at least one of the supplemental element and the supplemental information.

9. The method of claim 1 wherein the proxy is a service proxy that controls network access to at least one of the requesting client and the servicing client through a firewall and wherein the method further includes:
establishing the controlled communication channel between the service proxy and at least one of the requesting client and the servicing client through the firewall; and
using the controlled communication channel by the service proxy to at least one of receive the first message and send the second message.

10. The method of claim 9 wherein establishing the controlled communication channel comprises:
using presence service credentials associated with at least one of the servicing client and the requesting client.

11. A computer readable medium containing a computer program, executable by a machine, for providing supplemental information in a presence client-based service message, the computer program comprising executable instructions for:
receiving a first message from one of a requesting client and a servicing client of a presence service, the first message compatible with a transmission format that provides a service element for carrying service information related to a service associated with the servicing client and made indirectly available to the requesting client via the presence service;
identifying a supplemental element in the first message that indicates supplemental information is allowed, wherein the supplemental information is information other than the service information;
generating a second message compatible with the transmission format, the second message including the supplemental information as indicated by the supplemental element and the service element comprising the service information; and
sending the second message to the other of the requesting client and the servicing client, wherein at least one of the first message is received and the second message is transmitted via a controlled communication channel that supports network access to at least one of the requesting client and the servicing client via a proxy associated with the presence service.

12. The computer readable medium of claim 11 wherein instructions for generating the second message further comprise instructions for:
selecting supplemental information based on attributes associated with at least one of the service, the service information, and the supplemental element; and
inserting the selected supplemental information into the second message as indicated by the supplemental element.

13. The computer readable medium of claim 12 wherein instructions for selecting the supplemental information include instructions for:
determining at least one of a service type, a service content, and a service protocol associated with the service, and at least one of a MIME type, a size, a font, a color, a location, and a preferred display associated with the supplemental element; and
choosing the supplemental information based on at least one of the service type, the service content, and the service protocol associated with the service and based on at least one of the MIME type, the size, the font, the color, the location, and the preferred display associated with the supplemental element.

14. The computer readable medium of claim 12 wherein the instructions for inserting the selected supplemental information into the second message comprises instructions for using at least a portion of the first message including the supplemental element as content in the second message and one of replacing in the content the supplemental element with the supplemental information, and placing in the content the supplemental information into the supplemental element.

15. The computer readable medium of claim 11 wherein instructions for generating the second message further comprise instructions for:
detecting whether the supplemental element of the first message includes the supplemental information; and
inserting the supplemental information in the first message into the second message when the supplemental information is so detected.

16. The computer readable medium of claim 11 wherein instructions for at least one of receiving the first message and sending the second message comprise instructions for using the controlled communication channel associated with the presence service.

17. The computer readable medium of claim 11 wherein the proxy is a service proxy that controls network access to at least one of the requesting client and the servicing client through a firewall and wherein the program further includes instructions for:
establishing the controlled communication channel between the service proxy and at least one of the requesting client and the servicing client; and
using the controlled communication channel by the service proxy to at least one of receive the first message and send the second message.

18. The computer readable medium of claim 17 wherein instructions for establishing the controlled communication channel include instructions for using presence service credentials associated with at least one of the servicing client and the requesting client.

19. A system for providing supplemental information in a presence client-based service message between a sending client and a receiving client, wherein the sending client and the receiving client are clients of a presence service, the system comprising:
an intermediary server associated with the presence service and communicatively coupled to at least one of the sending client and the receiving client via a controlled communication channel that supports network access to at least one of the sending client and the receiving client, the server comprising:
a communication interface for receiving a first message from the sending client, the first message compatible with a transmission format that provides a service element for carrying service information related to a service associated with a servicing client and made indirectly available to a requesting client via the presence service; and
an information insertion module configured to identify a supplemental element in the first message indicating supplemental information is allowed, wherein the supplemental information is information other than the service information, to generate a second message compatible with the transmission format, the second message including the service element comprising the service information, and supplemental information as indicated by the supplemental element, and to send the second message to the receiving client via the communication interface, wherein at least one of the first message is received and the second message is transmitted via the controlled communication channel.

20. The system of claim 19 wherein the sending client is one of a requesting client and a servicing client and the receiving client is the other of the servicing client and the requesting client and wherein the service information includes at least one of a request from the requesting client and a response from the servicing client.

21. The system of claim 19 wherein the information insertion module is further configured to select supplemental information based on attributes associated with at least one of the service, the service information, and the supplemental element, and to insert the selected supplemental information into the second message.

22. The system of claim 21 wherein the information insertion module is further configured to use at least a portion of the first message including the supplemental element as content in the second message and to one of replace in the content the supplemental element with the supplemental information, and place in the content the supplemental information into the supplemental element.

23. The system of claim 21 wherein the information insertion module is further configured to determine at least one of a service type, a service content, and a service protocol associated with the service, and at least one of a MIME type, a size, a font, a color, a location, and a preferred display associated with the supplemental element, and to choose the supplemental information based on at least one of the service type, the service content, and the service protocol associated with the service and based on at least one of the MIME type, the size, the font, the color, the location, and the preferred display associated with the supplemental element.

24. The system of claim 19 wherein the information insertion module is further configured to detect whether the supplemental element of the first message includes the supplemental information, and to insert the detected supplemental information in the first message into the second message when the supplemental information is so detected.

25. The system of claim 19 wherein the intermediary server further includes a presence service configured to send a notification message including at least one of the supplemental element and the supplemental information.

26. The system of claim 19 wherein the intermediary server includes a service proxy that controls network access to at least one of the sending client and the receiving client through a firewall, the service proxy configured to use presence service credentials associated with at least one of the sending client and the receiving client to establish the controlled communication channel that traverses the firewall and communicatively connects the service proxy to at least one of the sending client and the receiving client.

27. A system for providing supplemental information in a presence client-based service message between a sending client and a receiving client, wherein the sending client and the receiving client are clients of a presence service, the system comprising:
means for receiving a first message from one of a requesting client and a servicing client of a presence service, the first message compatible with a transmission format that provides a service element for carrying service information related to a service associated with the servicing client and made indirectly available to the requesting client via the presence service;
means for identifying a supplemental element in the first message that indicates supplemental information is allowed, wherein the supplemental information is information other than the service information;
means for generating a second message compatible with the transmission format, the second message including the supplemental information as indicated by the supplemental element and the service element comprising the service information; and
means for sending the second message to the other of the requesting client and the servicing client, wherein at least one of the first message is received and the second message is transmitted via a controlled communication channel that supports network access to at least one of the requesting client and the servicing client via a proxy associated with the presence service.
